(19) United States
(12) Patent Application Publication
(10) Pub. No.: US 2026/0029227 A1
(43) Pub. Date: Jan. 29, 2026

(54) Measuring Wellhead Displacement Using Speckle Reflectometry

(71) Applicant: Saudi Arabian Oil Company, Dhahran (SA)

(72) Inventors: Damian Pablo San Roman Alerigi, Al-Khobar (SA); Sameeh Issa Batarseh, Dhahran (SA)

(21) Appl. No.: 18/782,615

(22) Filed: Jul. 24, 2024

(51) Int. Cl. G01B 11/14; E21B 41/00; G01S 7/481; G01S 17/89

(52) U.S. Cl. CPC G01B 11/14; E21B 41/00; G01S 7/4814; G01S 17/89

(57) ABSTRACT

Systems and methods for measuring wellhead displacement include receiving a speckle interferogram from an imaging sensor based on infrared light transmitted to and reflected from a portion of a wellhead; correlating the speckle interferogram with a reference speckle interferogram, the reference speckle interferogram indicating a previous position of the portion of the wellhead; and measuring a displacement of the wellhead based on the correlation of the speckle interferogram and the reference speckle interferogram.

### TECHNICAL FIELD

This disclosure generally relates to measuring wellhead displacement.

### BACKGROUND

Wellheads and hydrocarbon production surface structures can be subject to complex forces and thermal gradients that cause structural changes or damage including, for example, anisotropic dilation, fatigue, and displacement, among others. These effects can damage the wellheads, the surface structures, or both. Conventionally, structural changes are measured manually as part of routine inspections. Times that measurements are taken may be sporadic due to the number of wells, remote locations of the wells, and weather conditions.

### SUMMARY

Wellheads are a critical part of oil/gas/geothermal drilling, completion and production systems, acting as both the structural and pressure containing interface. Wellheads include equipment mounted at the opening of the well to regulate and monitor hydrocarbon extraction from a subsurface formation, and typically includes three components: a casing head, a tubing head, and a production tree (colloquially known as a Christmas tree). The casing head can be fitted with valves and plugs to access the well casing. The tubing head can position the tubing correctly in the well and provides reliable well access. The tubing head can be sealed to enable removal of the production tree with pressure in the casing. The production tree can include multiple types of valves and gauges such as a master gate valve, a pressure gauge, a wing valve, a swab valve, and a choke and a number of check valves. The production tree provides production operation control and monitoring. The wellhead provides casing and tubing suspension, and a means to attach a blowout preventer during drilling to avoid high pressure formation induced blowouts.

During the well service life, the wellhead can undergo movement and displacement, often visually observed as a height change (e.g., growth) of the wellhead compared with a previous position. This can be caused by a host of factors including static, thermal, and pressure induced complex wellhead loadings. Wellhead growth caused by temperature and pressure effects during production could be severe and critical, causing well integrity failure and surface equipment damage, sometimes with catastrophic consequences at huge safety risks and economic losses. Being able to detection, quantify and mitigate displacement can have significant economic and safety impact to production fields.

This disclosure provides an approach for measuring wellhead displacement using speckle reflectometry. The wellhead, or a portion of the wellhead, can be illuminated by an infrared light source. Light scattered and reflected by the wellhead can be collected by an imaging sensor, and a speckle interferogram can be constructed based on the reflected light. Interferograms from two or more instances in time can be compared to determine displacements of the wellhead. The wellhead displacement can be used to trigger corrective actions, for example, when the displacement exceeds a threshold displacement.

Implementations of the systems and methods of this disclosure can provide various technical benefits. A speckle reflectometry approach enables submillimeter features of the wellhead to be tracked over time. The submillimeter features can be linked to the integrity of the wellhead and indicate damage (e.g., erosion, corrosion, and micro-torsions). The speckle reflectometry system can obtain continuous measurement in real-time. The speckle interferogram can obtain wellhead measurements in the presence of environmental and weather based occlusions (e.g., fog, rain, light sandstorms). The speckle reflectometry system can be resilient to deformations (e.g., thermal expansion, mechanical deformation) of the optical system because the speckle reflectometry system can be recalibrated in place using a predefined speckle pattern.

The speckle reflectometry system enables minute and bulk changes in the structure of the wellhead to be tracked over time by selecting different wavelengths of illumination. The speckle reflectometry system can also reveal material degradation of the wellhead such as corrosion and erosion. Buildup of stress and strain on sensitive areas of the wellhead can be measured using a speckle reflectometry system with cross-polarized light. Monitoring degradation of surface equipment such as wellheads can reduce fugitive leaks (e.g., irregular emissions of gases or other fluids) and enable preventive maintenance of the surface equipment.

The speckle reflectometry system can be adapted for desert environments by tuning emission wavelengths away from the solar maxima and water absorption wavelengths. Optical components of the system can be mounted on moving stages that can be adjusted to compensate for thermal dilations or recoil of the optical system. The moving stages can be adjusted based on continuous monitoring of the temperature of the system and the deformation of a known pattern. The speckle reflectometry system includes fewer optical components than other systems (e.g., LIDAR) enabling the system to be effectively cooled using passive cooling methods and/or a thermo-electric cooling system.

The details of one or more implementations of these systems and methods are set forth in the accompanying drawings and the description below. Other features, objects, and advantages of these systems and methods will be apparent from the description and drawings, and from the claims.

### DESCRIPTION OF DRAWINGS

FIG. 1 is a schematic of a wellhead assembly.

FIG. 2 is an illustration of a speckle reflectometry measurement system.

FIG. 3 is a block diagram of a speckle reflectometry measurement system.

FIG. 4 is a block diagram of an optical portion of the speckle reflectometry measurement system.

FIG. 5 is a flow chart for a method for measuring wellhead displacement.

FIG. 6 is a diagram showing a photonic sensing system used on a wellhead structure.

FIG. 7 is a block diagram illustrating an example computer system used to provide computational functionalities associated with described algorithms, methods, functions, processes, flows, and procedures according to some implementations of the present disclosure.

Like reference symbols in the various drawings indicate like elements.

### DETAILED DESCRIPTION

Wellheads are a critical part of oil/gas/geothermal drilling, completion, and production systems, acting as both the structural and pressure containing interface. Wellheads include equipment mounted at the opening of the well to regulate and monitor hydrocarbon extraction from a subsurface formation, and typically includes three components: a casing head, a tubing head, and a production tree (colloquially known as a Christmas tree). The casing head can be fitted with valves and plugs to access the well casing. The tubing head can position the tubing correctly in the well and provides reliable well access. The tubing head can be sealed to enable removal of the production tree with pressure in the casing. The production tree can include multiple types of valves and gauges such as a master gate valve, a pressure gauge, a wing valve, a swab valve, and a choke and a number of check valves. The production tree provides production operation control and monitoring. The wellhead provides casing and tubing suspension, and a means to attach a blowout preventer during drilling to avoid high pressure formation induced blowouts.

During the well service life, the wellhead can undergo movement and displacement, often visually observed as a height change (e.g., growth) of the wellhead compared with a previous position. This can be caused by a host of factors including static, thermal, and pressure induced complex wellhead loadings. Wellhead growth caused by temperature and pressure effects during production could be severe and critical, causing well integrity failure and surface equipment damage, sometimes with catastrophic consequences at huge safety risks and economic losses. Being able to detection, quantify and mitigate displacement can have significant economic and safety impact to production fields.

This disclosure provides an approach for measuring wellhead displacement using speckle reflectometry. The wellhead, or a portion of the wellhead, can be illuminated by an infrared light source. Light scattered and reflected by the wellhead can be collected by an imaging sensor, and a speckle interferogram can be constructed based on the reflected light. Interferograms from two or more instances in time can be compared to determine displacements of the wellhead. The wellhead displacement can be used to trigger corrective actions, for example, when the displacement exceeds a threshold displacement.

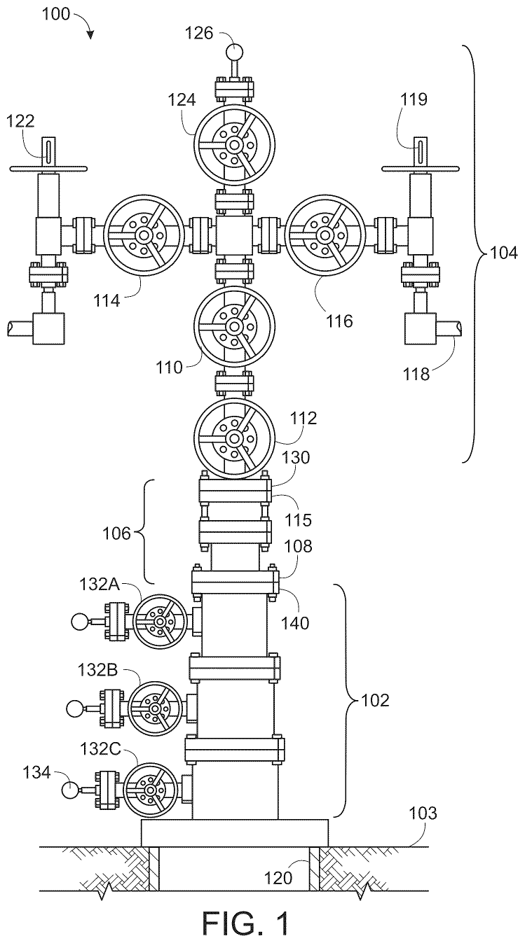

FIG. 1 illustrates a wellhead assembly 100 at a surface 116 of a wellbore 120. The wellhead assembly 100 includes a casing spool 102, a production tree 104 fluidly coupled to the wellhead 102, and a tubing bonnet assembly 106 residing between and fluidly coupled to the wellhead 102 and the production tree 104. The tubing bonnet assembly 106 is attached, on a bottom end 108, to a top flange 140 of a tubing spool 142 of the wellhead 102. The tubing bonnet assembly 106 is attached, on a top end 115, to a bottom flange 130 of a valve 132 (for example, a master valve) of the production tree 104.

The wellhead assembly 100 provides a structural and pressure-containing interface between the wellbore 120 and hydrocarbon production equipment. The production tree 104 includes valves 132 to control the pressure and flow of hydrocarbons from the wellbore 120 to the hydrocarbon production equipment. The wellhead assembly 100 can be exposed to harsh environments that may result in structural changes or damage to the wellhead assembly 100 such as anisotropic dilation, fatigue, displacement, corrosion, etc. The structural changes or damage can impair the functioning of the wellhead assembly 100. Without consistent measurement and monitoring, changes or damage to the wellhead assembly 100 could be unnoticed until a failure of the wellhead assembly 100 or its subcomponents.

The casing spool 102 includes casing annulus valves 132A, 132B, and 132C are illustrated. The casing annulus valves 132A-132C control fluid flow in the annular space of wellbore 100. A pressure gauge 134 enables pressure readings at the casing spool 102.

The wellhead assembly 100 includes a system of valves, adapters, and other devices that enable pressure control of a well. In examples, the wellhead includes a Christmas tree. For example, valves above ground level 103 are arranged in a crucifix type pattern and are colloquially referred to as a Christmas tree. In some embodiments, a Christmas tree is an assembly of valves, casing spools, and fittings used to regulate the flow of pipes in an oil well, gas well, water injection well, water disposal well, gas injection well, condensate well, and other types of well. For case of description, particular components are described with respect to the wellhead assembly 100. However, the wellhead assembly 100 can include any number of components that regulate the flow of hydrocarbons. In some examples, the wellhead assembly 100 includes a frac stack, frac tree, composite frac tree, production tree, and the like.

The wellhead assembly 100 includes multiple valves. The valves include varying valve configurations and combinations of manual and/or actuated (e.g., hydraulic or pneumatic) valves. As shown in FIG. 1, two lower valves are referred to as master valves, an upper master valve 110 and lower master valve 112. The master valves 110 and 112 are in a fully open position after completion of the well and are not opened or closed when the well is flowing (except in an emergency) to prevent erosion of the valve sealing surfaces. In some embodiments, the lower master valve 112 is manually operated and the upper master valve 110 is hydraulically actuated. In some implementations, the upper master valve 110 is controlled from a remote location and enables remote shutting in of the well in the event of emergency.

The wellhead assembly 100 includes a kill wing valve 114 and a flow wing valve 116. In some embodiments, the wing valves 114 and 116 are hydraulically actuated. The flow wing valve 116 enables hydrocarbons to flow from the well, to a flowline 118. The flowline 118 defines the path that the hydrocarbons take to production facilities (or the path water or gas will take from production to the well in the case of injection wells). An emergency shutdown device 119 can be used to remotely shut in the well in case of an emergency. In examples, kill wing valve 114 is used for injection of fluids such as corrosion inhibitors or methanol to prevent hydrate formation. In some embodiments, the kill wing valve 114 is manually operated. As shown in FIG. 1, a pressure gauge 122 at the production tree 104 can be used to monitor pressure at the wellhead.

The wellhead assembly 100 also includes a swab valve 124 that is used for well interventions like wireline and coiled tubing. For such operations, a lubricator is rigged up onto the top of the production tree 104 and the wire or coil is lowered through the lubricator, past the swab valve 124 and into the well. In some examples, the swab valve 124 is manually operated. A needle valve 126 is used to start, stop, and regulate the flow rate at the wellhead. In some embodiments, the needle valve 126 enables rigging down equipment from the top of the wellhead assembly 100 with the well flowing while ensuring two barriers separate hydrocarbons from the swab valve 124.

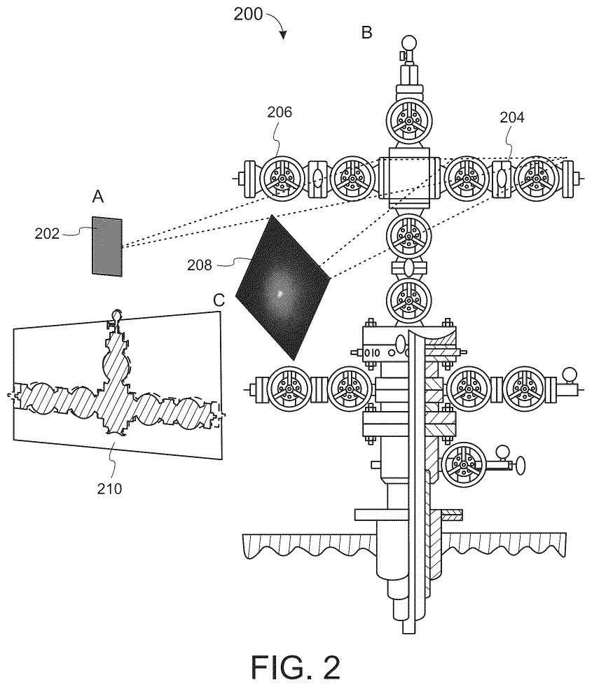

FIG. 2 illustrates a speckle reflectometry system 200 used to measure displacement of a wellhead 206. A light source 202 of the system 200 emits light to illuminate a portion 204 of the wellhead 206. The light is diffusively scattered by the portion 204 of the wellhead 206. An optical system 208 captures the back-scattered light (e.g., the light diffusively scattered from the wellhead 206 in the direction toward the optical system 208). The optical system 208 generates a speckle interferogram using the back-scattered light. Displacements of the wellhead 206 can be determined based on the speckle interferogram. A light detection and ranging (LIDAR) system can be coupled with the light source 202 and the optical system 208 to generate a point cloud 210 representing the position of the wellhead. Time-lapse data including interferograms and/or point clouds can be processed using cross-correlation and/or machine learning techniques to track wellhead structures at coarse and fine scales. The point cloud 210 can be combined with the displacement measured using the speckle interferogram to generate a three-dimensional (3D) mapping of the wellhead 206 including coarse scale structures from the LIDAR measurements and fine scale structures from the speckle reflectometry.

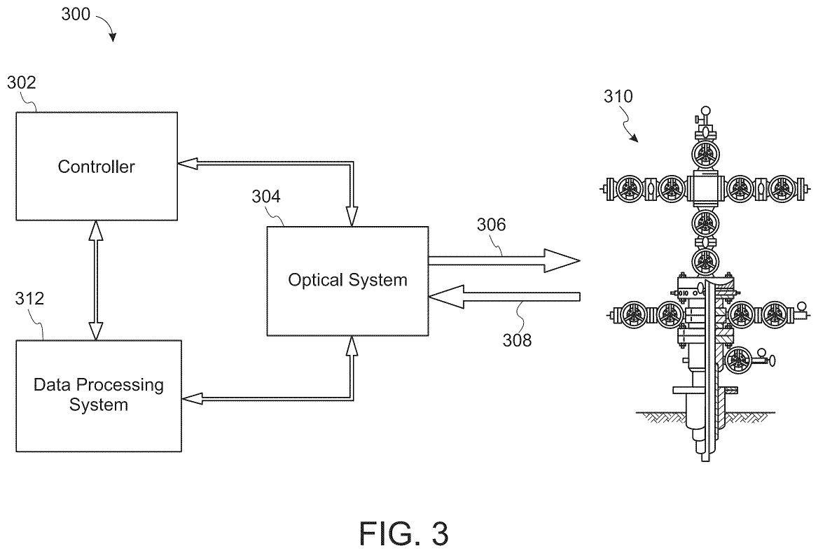

FIG. 3 is a block diagram of an example speckle reflectometry system 300. The system 300 includes a controller 302, an optical system 304, and a data processing system 312. The system 300 emits coherent light 306 (e.g., light with in-phase wavelengths of the same length). The system 300 receives diffusely reflected light 308 that has been back-scattered from the wellhead structure 310.

The controller 302 includes electronics to control the emission and detection of light. For example, the controller can include timers, function generators, photodetectors, analog-to-digital converters, and hardware storage devices. The controller is in electronic communication with the optical system 304 and the data processing system 312. For example, the controller 302 can be hard-wired to one or both of the optical system 304 and the data processing system 312. In some implementations, the controller 302 can communicate with one or both of the optical system 304 and the data processing system 312 over a wireless communication network (e.g., cellular, Wi-Fi, short range radio communications).

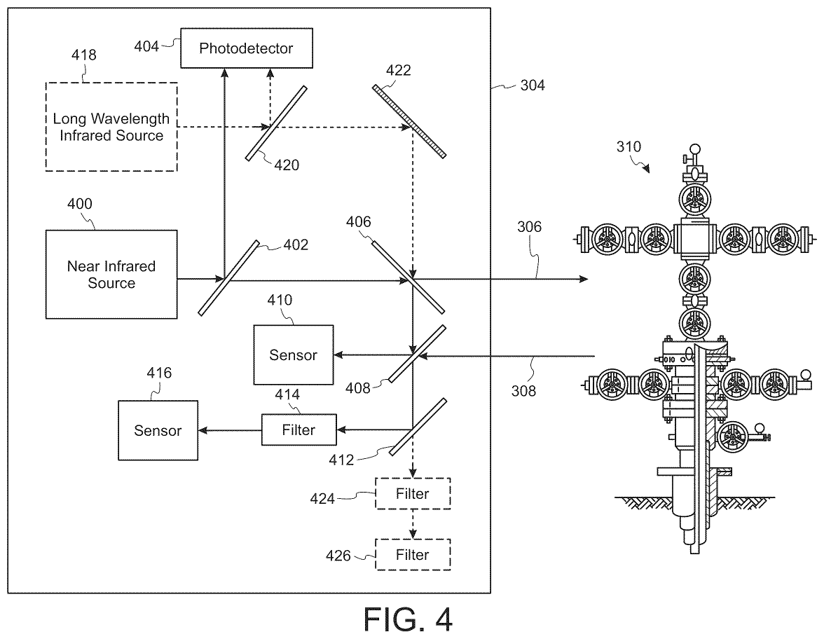

The optical system 304 includes, for example, optical elements, optomechanical mounts, electronics, and light sources, (e.g., near infrared (NIR) for speckle generation and long wavelength infrared (LWIR) for phase-shift structured LIDAR). The illumination can use one or multiple lasers or super luminescent diode (SLD) sources fitted with spatial filters, optical condensers, and other optical components to illuminate the area of interest on the wellhead 310. The optical system 304 can collect light using, for example, integrating spheres, beam condensers, and other imaging optics to collect, collimate, and propagate the beam through a sensor's aperture and into an optical analysis path. The light source for speckle generation can be chosen to increase scattering/diffuse reflectance from the surface of the wellhead. The wavelength of the LIDAR source can be chosen in the LWIR spectrum to minimize scattering due to the roughness of the object (e.g., increase specular reflection). In both cases, the wavelength ranges of the light sources can be chosen to minimize absorption from atmospheric gases and water vapor and reduce sensor saturation from solar radiation. A NIR light source can have a wavelength, in the 1.5-2 micrometer (μm) range, for example. An example wavelength range for a LWIR source is 8 to 14 μm. Other wavelength ranges can be chosen depending on the needs of the particular implementation. An example optical system is described in more detail in reference to FIG. 4.

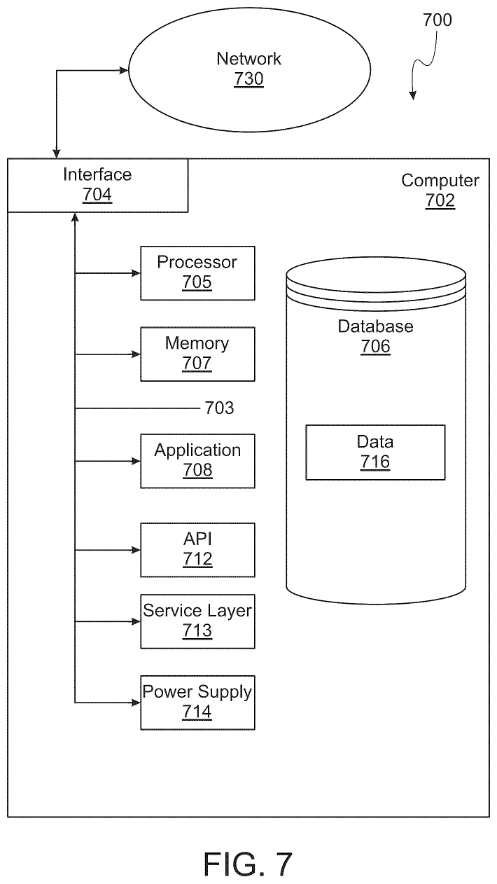

The data processing system 312 can receive image data from the optical system 304. The data processing system 312 can be similar to the computer system of FIG. 7. The data processing system 312 can use the interferograms generated by the optical system 304 to infer displacements of the wellhead 310 using cross-correlations and 3D inverse mapping techniques. In some implementations, the 3D mapping uses a sparse point cloud from a LIDAR system to generate a coarse mapping of the structure while the speckle interferogram provides high-resolution displacement information. In addition, the data processing system 312 can use cross-correlation of the raw and 3D structured data to quickly detect anomalies. The collected data can be further investigated by the data processing system 312 using temporal analysis or other methods (e.g., machine learning) in a post-analysis step. The data processing system 312 stores a time-lapse of the data that can be later accessed to determine relative displacement of the structure. The data processing system can use computer vision and deep-neural networks for quick inference of displacements and anomalies. For example, the data processing system can use image segmentation techniques to identify and track locations of features in the 3D mapping to detect anomalies in the wellhead structure through time.

FIG. 4 is an example optical system 304 for measuring displacements of a wellhead. The optical system 304 includes light sources, optical elements, and sensor to transmit, transform, and collect light. The various system components can be mounted on optomechanical mounts that can be adjusted (manually or automatically using electric motors) to align and calibrate the optical system 304.

The optical system 304 includes a NIR source 400 such as a laser or SLD. The light emitted from the NIR source 400 transmits to a beam splitter 402. The beam splitter 402 can be, for example, a 1/99 beam splitter that reflects 1% of the light and transmits 99% of the light. The 1% of reflected light can be directed to a photodetector 404. The photodetector 404 can be used to measure amplitude and duration of the emitted light. The transmitted light proceeds to beam splitter 406. Beam splitter 406 can be, for example, a 25/75 beam splitter. A portion of the light is directed to the detection part of the system, and a portion of the light is transmitted toward the wellhead 310 to illuminate a portion of the wellhead.

The detection part of the optical system 304 receives the back-scattered light 308 from the wellhead. The light 308 propagates to beam splitter 408 where a portion is transmitted, and a portion is reflected. The transmitted portion proceeds to a sensor 410 (e.g., a complementary metal-oxide-semiconductor (CMOS) sensor or a charge-coupled device (CCD) sensor). The sensor 410 captures a raw image of the back-scattered light. The reflected portion is combined with the light from beam splitter 406. The reflected portion propagates to dichroic mirror 412. The dichroic mirror can be designed, for example, to reflect NIR wavelengths and transmit LWIR wavelengths. The NIR light is reflected by the dichroic mirror 412 to filter 414 and then to sensor 416. The filter 414 can be, for example, a bandpass filter that allows only certain wavelengths to pass to the sensor 416. The combination of light from beam splitter 406 and the back-scattered light 308 can form the speckle interferogram at sensor 416.

The optical system 304 can also include a LWIR light source 418 to perform phase-shifted LIDAR measurements on the wellhead 310. The light from the LWIR source 418 propagates to beam splitter 420 where a portion of the light is picked off and directed to photodetector 404. The light transmitted through beam splitter 420 propagates to mirror 422 and then to beam splitter 406 where a portion is directed toward the wellhead 310 and a portion is directed toward the detection part of the optical system 304. The LWIR light included in the back-scattered light 308 transmits through the dichroic mirror 412, through filter 424, and to sensor 426 where it is captured and recorded.

The light sources 400, 418, photodetector 404, and sensors 410, 416, and 426 can be operated by the controller 302. The sensors 410, 416, and 426 can transmit captured data to the data processing system 312 for processing and analysis.

The optical system 304 can be periodically calibrated by projecting a specific light pattern on to the wellhead 310 and detecting the back-scattered speckle pattern. Based on deviations in the detected speckle pattern when compared with previous calibrations, the controller 302 can adjust positions of the optical components in the optical system 304 to remedy the deviations. In some implementations, a reference object (e.g., an external and independent object) can be placed for use in calibrating the optical system 304. For example, the reference object can generate a repeatable speckle pattern, and distortions or changes to the speckle pattern can be correlated with adjustments to the optical system 304 to recover the undistorted speckle pattern. In some implementations, the optical system 304 includes an internal element (e.g., a flat mirror or a known curved surface) that can be used to perform a system self-calibration in a similar manner.

In some implementations, the optical system 304 can include many NIR sources multiplexed together to measure displacements of multiple features on the wellhead. For example, the optical system 304 can include 10 or more NIR sources illuminating disparate features on the wellhead. In some implementations, the system 300 includes multiple optical systems 304 to measure displacements of multiple features on the wellhead.

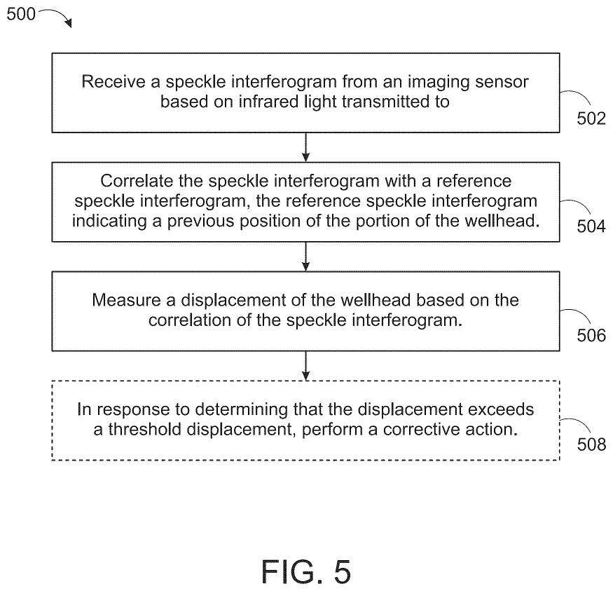

FIG. 5 is a flow chart for an example method 500 for measuring displacement of a wellhead. The method 500 can be implemented on a data processing system (e.g., data processing system 312, or the computer system of FIG. 7).

The data processing system receives a speckle interferogram from an imaging sensor based on infrared light transmitted to and reflected from a portion of a wellhead (step 502). The data processing system can receive the speckle interferogram in real-time from the imaging sensor. In some implementations, the data processing system accesses a speckle interferogram that was previously collected by an imaging sensor and stored in a data store.

The data processing system correlates the speckle interferogram with a reference speckle interferogram (step 504). The reference speckle interferogram indicates a previous position of the portion of the wellhead. The data processing system performs, for example, a cross-correlation between the speckle interferogram and the reference speckle interferogram to determine locations on the portion of the wellhead that have moved. These areas can be indicated by portions of the interferograms with poor correlation coefficients (e.g., correlation coefficients with values away from 1).

In some implementations, the data processing system uses a trained machine learning model to correlate the speckle interferogram with the reference speckle interferogram. The machine learning model can take as input the two interferograms and produce as output the correlation value. Additionally, or alternatively, the machine learning model can produce as output locations in the interferograms with poor correlation.

The data processing system measures a displacement of the wellhead based on the correlation of the speckle interferogram and the reference speckle interferogram (step 506). The data processing system is capable of determining submillimeter displacements based on the speckle interferograms. For example, the data processing system can determine displacements of a half-wavelength of the source light or more.

In some implementations, the data processing system iteratively measures displacements of the portion of the wellhead at multiple instances of time to generate a time-history of the displacements. The time-history of displacements can be used to assess the movement of the wellhead over time. The time-history can be used to identify anomalies in the wellhead and.or changes in the performance or condition of the wellhead. The data processing system can predict anomalies of the wellhead using a machine learning model that takes as input the time-history of the displacements and outputs the location and/or the severity of the anomalies.

In response to determining that the displacement exceeds a threshold displacement, the data processing system can perform a corrective action to remedy the detected displacement. For example, the data processing system can generate an alert that the displacement exceeds the threshold displacement. The data processing system can generate an audio alert, a visual alert or both. The alert can indicate a preventive maintenance task to be performed by personnel. In some implementations, the data processing system can adjust valve positions to reduce the flow of hydrocarbons in the wellhead based on determining that the displacement exceeds the threshold displacement.

In some implementations, the data processing system receives LIDAR data from a LIDAR system directed at the portion of the wellhead. The data processing system can generate a point cloud of data representing the portion of the wellhead based on the LIDAR data.

The data processing system can generate a three-dimensional representation of the portion of the wellhead based on the point cloud data and the speckle interferogram. For example, the data processing system can generate the 3D representation of the portion of the wellhead by performing a three-dimensional inverse mapping of the portion of the wellhead. The inverse mapping, for example, creates a 3D surface based on the speckle interferogram. The data processing system can generate a coarse 3D representation of the wellhead using the point cloud data, and the data processing system can generate fine features (e.g., submillimeter scale features) in the 3D representation using the speckle interferogram.

The data processing system can identify an anomaly in the portion of the wellhead by comparing the 3D representation with a reference 3D representation. The reference 3D representation can be, for example, a baseline 3D representation or a 3D representation from a previous moment in time. In some implementations, the data processing system records the locations of structures on the wellhead at multiple instances in time to generate a time-history of the structural displacements. The data processing system can process the time-history to identify data trends indicative of potential failures or damage.

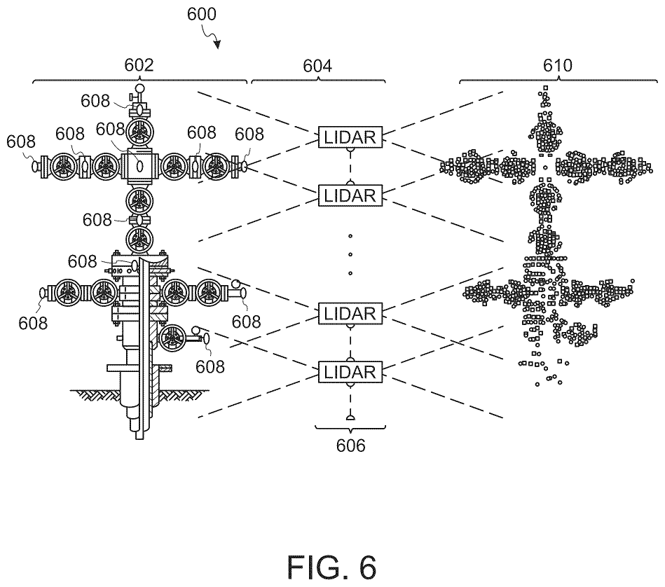

FIG. 6 is a diagram showing an example of a photonic sensing system 600 used on a wellhead structure 602. The photonic sensing system 600 includes a LIDAR array and projection 604. The LIDAR array can be mounted on a rack. Each LIDAR 606 can incorporate a laser meter to determine the distance between each LIDAR 606 and the ground. These features can make the photonic sensing system 600 capable of measuring absolute displacement with reference to the ground. Reference/beacon markers 608 of the LIDAR array are shown using white circles on the wellhead structure 602. The photonic sensing system 600 produces a point cloud 610 representing points on the wellhead structure 602.

Each of the LIDARs can be mounted on a rack. Each LIDAR can use a laser ranging system at the bottom of the LIDAR to monitor the distance to the next measurement device (for example, below the LIDAR). This enables the process to know the relative position of each measurement device and hence improve the axial/longitudinal displacement characterization of the wellhead 602.

The horizontal (H) and vertical (V) resolution of LIDAR sensors can vary depending on the configuration of the photonic sensing system used. Thus, a resolution Δ_{h,v}, can be represented as a function of a distance r_{LIDAR} from a circumscribing cylinder to an optical output and the angular resolution ϕ_{H/V}, for example given by:

$${Δ}_{h , v} = {r}_{LIDAR} tan {ϕ}_{h , v} .$$

A field of view (FOV) of a LIDAR sensor can typically span, for example, from 170-360 degrees in a horizontal direction and 5-30 degrees in a vertical direction. These spans and the distance to the target can determine the number of LIDARs needed in the array configuration to characterize the position of the wellhead 602. U.S. Pat. No. 11,725,504, which is hereby incorporated by reference in its entirety, describes further details of a structured light system and LIDAR system that can be used in contactless measurements of wellhead displacement.

FIG. 7 is a block diagram of an example computer system 700 used to provide computational functionalities associated with described algorithms, methods, functions, processes, flows, and procedures described in the present disclosure, according to some implementations of the present disclosure. The illustrated computer 702 is intended to encompass any computing device such as a server, a desktop computer, a laptop/notebook computer, a wireless data port, a smart phone, a personal data assistant (PDA), a tablet computing device, or one or more processors within these devices, including physical instances, virtual instances, or both. The computer 702 can include input devices such as keypads, keyboards, and touch screens that can accept user information. Also, the computer 702 can include output devices that can convey information associated with the operation of the computer 702. The information can include digital data, visual data, audio information, or a combination of information. The information can be presented in a graphical user interface (UI) (or GUI).

The computer 702 can serve in a role as a client, a network component, a server, a database, a persistency, or components of a computer system for performing the subject matter described in the present disclosure. The illustrated computer 702 is communicably coupled with a network 730. In some implementations, one or more components of the computer 702 can be configured to operate within different environments, including cloud-computing-based environments, local environments, global environments, and combinations of environments.

At a high level, the computer 702 is an electronic computing device operable to receive, transmit, process, store, and manage data and information associated with the described subject matter. According to some implementations, the computer 702 can also include, or be communicably coupled with, an application server, an email server, a web server, a caching server, a streaming data server, or a combination of servers.

The computer 702 can receive requests over network 730 from a client application (for example, executing on another computer 702). The computer 702 can respond to the received requests by processing the received requests using software applications. Requests can also be sent to the computer 702 from internal users (for example, from a command console), external (or third) parties, automated applications, entities, individuals, systems, and computers.

Each of the components of the computer 702 can communicate using a system bus 703. In some implementations, any or all of the components of the computer 702, including hardware or software components, can interface with each other or the interface 704 (or a combination of both), over the system bus 703. Interfaces can use an application programming interface (API) 712, a service layer 713, or a combination of the API 712 and service layer 713. The API 712 can include specifications for routines, data structures, and object classes. The API 712 can be either computer-language independent or dependent. The API 712 can refer to a complete interface, a single function, or a set of APIs.

The service layer 713 can provide software services to the computer 702 and other components (whether illustrated or not) that are communicably coupled to the computer 702. The functionality of the computer 702 can be accessible for all service consumers using this service layer. Software services, such as those provided by the service layer 713, can provide reusable, defined functionalities through a defined interface. For example, the interface can be software written in JAVA, C++, or a language providing data in extensible markup language (XML) format. While illustrated as an integrated component of the computer 702, in alternative implementations, the API 712 or the service layer 713 can be stand-alone components in relation to other components of the computer 702 and other components communicably coupled to the computer 702. Moreover, any or all parts of the API 712 or the service layer 713 can be implemented as child or sub-modules of another software module, enterprise application, or hardware module without departing from the scope of the present disclosure.

The computer 702 includes an interface 704. Although illustrated as a single interface 704 in FIG. 7, two or more interfaces 704 can be used according to particular needs, desires, or particular implementations of the computer 702 and the described functionality. The interface 704 can be used by the computer 702 for communicating with other systems that are connected to the network 730 (whether illustrated or not) in a distributed environment. Generally, the interface 704 can include, or be implemented using, logic encoded in software or hardware (or a combination of software and hardware) operable to communicate with the network 730. More specifically, the interface 704 can include software supporting one or more communication protocols associated with communications. As such, the network 730 or the interface's hardware can be operable to communicate physical signals within and outside of the illustrated computer 702.

The computer 702 includes a processor 705. Although illustrated as a single processor 705 in FIG. 7, two or more processors 705 can be used according to particular needs, desires, or particular implementations of the computer 702 and the described functionality. Generally, the processor 705 can execute instructions and can manipulate data to perform the operations of the computer 702, including operations using algorithms, methods, functions, processes, flows, and procedures as described in the present disclosure.

The computer 702 also includes a database 706 that can hold data for the computer 702 and other components connected to the network 730 (whether illustrated or not). For example, database 706 can hold data 716 (e.g., resistivity data). For example, database 706 can be an in-memory, conventional, or a database storing data consistent with the present disclosure. In some implementations, database 706 can be a combination of two or more different database types (for example, hybrid in-memory and conventional databases) according to particular needs, desires, or particular implementations of the computer 702 and the described functionality. Although illustrated as a single database 706 in FIG. 7, two or more databases (of the same, different, or combination of types) can be used according to particular needs, desires, or particular implementations of the computer 702 and the described functionality. While database 706 is illustrated as an internal component of the computer 702, in alternative implementations, database 706 can be external to the computer 702.

The computer 702 also includes a memory 707 that can hold data for the computer 702 or a combination of components connected to the network 730 (whether illustrated or not). Memory 707 can store any data consistent with the present disclosure. In some implementations, memory 707 can be a combination of two or more different types of memory (for example, a combination of semiconductor and magnetic storage) according to particular needs, desires, or particular implementations of the computer 702 and the described functionality. Although illustrated as a single memory 707 in FIG. 7, two or more memories 707 (of the same, different, or combination of types) can be used according to particular needs, desires, or particular implementations of the computer 702 and the described functionality. While memory 707 is illustrated as an internal component of the computer 702, in alternative implementations, memory 707 can be external to the computer 702.

The application 708 can be an algorithmic software engine providing functionality according to particular needs, desires, or particular implementations of the computer 702 and the described functionality. For example, application 708 can serve as one or more components, modules, or applications. Further, although illustrated as a single application 708, the application 708 can be implemented as multiple applications 708 on the computer 702. In addition, although illustrated as internal to the computer 702, in alternative implementations, the application 708 can be external to the computer 702.

The computer 702 can also include a power supply 714. The power supply 714 can include a rechargeable or non-rechargeable battery that can be configured to be either user- or non-user-replaceable. In some implementations, the power supply 714 can include power-conversion and management circuits, including recharging, standby, and power management functionalities. In some implementations, the power-supply 714 can include a power plug to allow the computer 702 to be plugged into a wall socket or a power source to, for example, power the computer 702 or recharge a rechargeable battery.

There can be any number of computers 702 associated with, or external to, a computer system containing computer 702, with each computer 702 communicating over network 730. Further, the terms “client,” “user,” and other appropriate terminology can be used interchangeably, as appropriate, without departing from the scope of the present disclosure. Moreover, the present disclosure contemplates that many users can use one computer 702 and one user can use multiple computers 702.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs. Each computer program can include one or more modules of computer program instructions encoded on a tangible, non transitory, computer-readable computer-storage medium for execution by, or to control the operation of, data processing apparatus. Alternatively, or additionally, the program instructions can be encoded in/on an artificially generated propagated signal. The example, the signal can be a machine-generated electrical, optical, or electromagnetic signal that is generated to encode information for transmission to suitable receiver apparatus for execution by a data processing apparatus. The computer-storage medium can be a machine-readable storage device, a machine-readable storage substrate, a random or serial access memory device, or a combination of computer-storage mediums.

The terms “data processing apparatus,” “computer,” and “electronic computer device” (or equivalent as understood by one of ordinary skill in the art) refer to data processing hardware. For example, a data processing apparatus can encompass all kinds of apparatus, devices, and machines for processing data, including by way of example, a programmable processor, a computer, or multiple processors or computers. The apparatus can also include special purpose logic circuitry including, for example, a central processing unit (CPU), a field programmable gate array (FPGA), or an application specific integrated circuit (ASIC). In some implementations, the data processing apparatus or special purpose logic circuitry (or a combination of the data processing apparatus or special purpose logic circuitry) can be hardware- or software-based (or a combination of both hardware- and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with or without conventional operating systems, for example LINUX, UNIX, WINDOWS, MAC OS, ANDROID, or IOS.

The methods, processes, or logic flows described in this specification can be performed by one or more programmable computers executing one or more computer programs to perform functions by operating on input data and generating output. The methods, processes, or logic flows can also be performed by, and apparatus can also be implemented as, special purpose logic circuitry, for example, a CPU, an FPGA, or an ASIC.

Computer readable media (transitory or non-transitory, as appropriate) suitable for storing computer program instructions and data can include all forms of permanent/non-permanent and volatile/non-volatile memory, media, and memory devices. Computer readable media can include, for example, semiconductor memory devices such as random access memory (RAM), read only memory (ROM), phase change memory (PRAM), static random access memory (SRAM), dynamic random access memory (DRAM), erasable programmable read-only memory (EPROM), electrically erasable programmable read-only memory (EEPROM), and flash memory devices. Computer readable media can also include, for example, magnetic devices such as tape, cartridges, cassettes, and internal/removable disks.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, in a single implementation. Conversely, various features that are described in the context of a single implementation can also be implemented in multiple implementations, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations should not be understood as requiring such separation or integration in all implementations, and it should be understood that the described program components and systems can generally be integrated together in a single software product or packaged into multiple software products.

Accordingly, the previously described example implementations do not define or constrain the present disclosure. Other changes, substitutions, and alterations are also possible without departing from the spirit and scope of the present disclosure.

Furthermore, any claimed implementation is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

A number of implementations of these systems and methods have been described. Nevertheless, it will be understood that various modifications may be made without departing from the spirit and scope of this disclosure. Accordingly, other implementations are within the scope of the following claims.

### EXAMPLES

In an example implementation, a method for measuring wellhead displacement includes receiving a speckle interferogram from an imaging sensor based on infrared light transmitted to and reflected from a portion of a wellhead; correlating the speckle interferogram with a reference speckle interferogram, the reference speckle interferogram indicating a previous position of the portion of the wellhead; and measuring a displacement of the wellhead based on the correlation of the speckle interferogram and the reference speckle interferogram.

An aspect combinable with the example implementation includes in response to determining that the displacement exceeds a threshold displacement, performing a corrective action.

In another aspect combinable with any of the previous aspects, performing the corrective action includes generating an alert that the displacement exceeds the threshold displacement.

Another aspect combinable with any of the previous aspects includes receiving light detection and ranging (LIDAR) data from a LIDAR system directed at the portion of the wellhead; and generating a point cloud of data representing the portion of the wellhead.

Another aspect combinable with any of the previous aspects includes generating a three-dimensional representation of the portion of the wellhead based on the point cloud data and the speckle interferogram.

Another aspect combinable with any of the previous aspects includes identifying an anomaly in the portion of the wellhead by comparing the three-dimensional representation with a reference three-dimensional representation.

In another aspect combinable with any of the previous aspects, generating the three-dimensional representation of the portion of the wellhead includes performing a three-dimensional inverse mapping of the portion of the wellhead using a coarse mapping of a structure of the wellhead based on the point cloud data and fine resolution displacement data based on the speckle interferogram.

Another aspect combinable with any of the previous aspects includes iteratively measuring displacements of the portion of the wellhead at multiple instances of time to generate a time-history of the displacements.

Another aspect combinable with any of the previous aspects includes predicting anomalies of the wellhead using a machine learning model that takes as input the time-history of the displacements.

In another example implementation, a system for measuring wellhead displacement includes an infrared light source to illuminate a portion of the wellhead; optical elements to generate speckle interference using transmitted light from the infrared light source and reflected light from the portion of the wellhead; an imaging sensor to receive the speckle interference from the optical components to generate a speckle interferogram; and a computer system configured to measure a displacement of the wellhead based on the speckle interferogram.

In an aspect combinable with the example implementation, the infrared light source includes a near infrared light source.

In another aspect combinable with any of the previous aspects, the infrared light source includes a laser or a super luminescent diode.

In another aspect combinable with any of the previous aspects, the optical elements include one or more of a beam splitter, an optical lens, an optomechanical mount, and an optical filter.

In another aspect combinable with any of the previous aspects, the computer system is further configured to receive a speckle interferogram from an imaging sensor based on infrared light transmitted to and reflected from a portion of a wellhead; correlate the speckle interferogram with a reference speckle interferogram, the reference speckle interferogram indicating a previous position of the portion of the wellhead; and measure a displacement of the wellhead based on the correlation of the speckle interferogram and the reference speckle interferogram.

Another aspect combinable with any of the previous aspects includes a light detection and ranging (LIDAR) system to generate a point cloud of data representing the wellhead.

In another aspect combinable with any of the previous aspects, the LIDAR system includes a long-wavelength infrared light source.

In another aspect combinable with any of the previous aspects, the computer system is further configured to receive LIDAR data from the LIDAR system directed at the portion of the wellhead; and generating a point cloud of data representing the portion of the wellhead.

In another aspect combinable with any of the previous aspects, the computer system is further configured to generate a three-dimensional representation of the portion of the wellhead based on the point cloud data and the speckle interferogram.

In another aspect combinable with any of the previous aspects, the computer system is further configured to identify an anomaly in the portion of the wellhead by comparing the three-dimensional representation with a reference three-dimensional representation.

In another aspect combinable with any of the previous aspects, generating the three-dimensional representation of the portion of the wellhead comprises performing a three-dimensional inverse mapping of the portion of the wellhead using a coarse mapping of a structure of the wellhead based on the point cloud data and fine resolution displacement data based on the speckle interferogram.

What is claimed is:

1. A method for measuring wellhead displacement, the method comprising:
receiving a speckle interferogram from an imaging sensor based on infrared light transmitted to and reflected from a portion of a wellhead;
correlating the speckle interferogram with a reference speckle interferogram, the reference speckle interferogram indicating a previous position of the portion of the wellhead; and
measuring a displacement of the wellhead based on the correlation of the speckle interferogram and the reference speckle interferogram.

2. The method of claim 1, further comprising in response to determining that the displacement exceeds a threshold displacement, performing a corrective action.

3. The method of claim 2, wherein performing the corrective action comprises generating an alert that the displacement exceeds the threshold displacement.

4. The method of claim 1, further comprising: receiving light detection and ranging (LIDAR) data from a LIDAR system directed at the portion of the wellhead; and generating a point cloud of data representing the portion of the wellhead.

5. The method of claim 4, further comprising: generating a three-dimensional representation of the portion of the wellhead based on the point cloud data and the speckle interferogram.

6. The method of claim 5, further comprising identifying an anomaly in the portion of the wellhead by comparing the three-dimensional representation with a reference three-dimensional representation.

7. The method of claim 5, wherein generating the three-dimensional representation of the portion of the wellhead comprises performing a three-dimensional inverse mapping of the portion of the wellhead using a coarse mapping of a structure of the wellhead based on the point cloud data and fine resolution displacement data based on the speckle interferogram.

8. The method of claim 1, further comprising: iteratively measuring displacements of the portion of the wellhead at multiple instances of time to generate a time-history of the displacements.

9. The method of claim 8, further comprising: predicting anomalies of the wellhead using a machine learning model that takes as input the time-history of the displacements.

10. A system for measuring wellhead displacement, the system comprising:
an infrared light source to illuminate a portion of the wellhead;
optical elements to generate speckle interference using transmitted light from the infrared light source and reflected light from the portion of the wellhead;
an imaging sensor to receive the speckle interference from the optical components to generate a speckle interferogram; and
a computer system configured to measure a displacement of the wellhead based on the speckle interferogram.

11. The system of claim 10, wherein the infrared light source comprises a near infrared light source.

12. The system of claim 10, wherein the infrared light source comprises a laser or a super luminescent diode.

13. The system of claim 10, wherein the optical elements comprise one or more of a beam splitter, an optical lens, an optomechanical mount, and an optical filter.

14. The system of claim 10, wherein the computer system is further configured to receive a speckle interferogram from an imaging sensor based on infrared light transmitted to and reflected from a portion of a wellhead;
correlate the speckle interferogram with a reference speckle interferogram, the reference speckle interferogram indicating a previous position of the portion of the wellhead; and
measure a displacement of the wellhead based on the correlation of the speckle interferogram and the reference speckle interferogram.

15. The system of claim 14, further comprising a light detection and ranging (LIDAR) system to generate a point cloud of data representing the wellhead.

16. The system of claim 15, wherein the LIDAR system comprises a long-wavelength infrared light source.

17. The system of claim 15, wherein the computer system is further configured to receive light detection and ranging (LIDAR) data from the LIDAR system directed at the portion of the wellhead; and generate a point cloud of data representing the portion of the wellhead.

18. The system of claim 17, wherein the computer system is further configured to generate a three-dimensional representation of the portion of the wellhead based on the point cloud data and the speckle interferogram.

19. The system of claim 18, wherein the computer system is further configured to identify an anomaly in the portion of the wellhead by comparing the three-dimensional representation with a reference three-dimensional representation.

20. The system of claim 18, wherein generating the three-dimensional representation of the portion of the wellhead comprises performing a three-dimensional inverse mapping of the portion of the wellhead using a coarse mapping of a structure of the wellhead based on the point cloud data and fine resolution displacement data based on the speckle interferogram.
